(19) United States
(12) Patent Application Publication
(10) Pub. No.: US 2003/0067497 A1
(43) Pub. Date: Apr. 10, 2003

(54) Method and device for modifying a pre-existing graphical user interface

(76) Inventor: Olivier Francis Pichon, Chelles (FR)

Correspondence Address: LERNER, DAVID, LITTENBERG,, KRUMHOLZ & MENTLIK, 600 SOUTH AVENUE WEST, WESTFIELD, NJ, 07090, US

(21) Appl. No.: 09/973,210

(22) Filed: Oct. 9, 2001

(51) Int. Cl. G09G 5/00

(52) U.S. Cl. 345/853

(57) ABSTRACT

A method for modifying a pre-existing graphical user interface (GUI) comprising a tree structure of GUI components each having a display area defined by area parameters and operable by a cursor control input device and at least some of the GUI components having listeners for responding to events from said input device is proposed.

The method comprises:

(a) providing at last some of the components with a component mode indicator identifying the component as being in an operation mode or in an edit mode,

(b) detecting a main trigger event inputted by a user;

(c) upon occurrence of a main trigger event, inhibiting all component listeners and updating component mode indicators based on the location of the cursor relative to the component areas at the time of the main trigger event,

(d) when at least one component is in edit mode, detecting area parameter change events from the cursor controlled input device,

(c) when such area parameter change events occur, identifying from these events a target component for area parameter change and applying corresponding area parameter changes to the target component.

Application to GUI customization without source code access, in particular in MVC (model-view-controller) design pattern environment.

The present invention generally relates to the customization of graphical user interfaces (GUI) in computer systems, in particular in object-oriented environment.

### BACKGROUND OF THE INVENTION

Creating a graphical user interface in a object-oriented programming language is common practice in software engineering, and a typical pseudo-code for a conventional graphical user interface would include the following basic operations;

creating a graphic panel that would hold most of the GUI's logic; herebelow is an example of a simple panel containing a single ‘OK’ button:

panel=new panel( )

button=new button(“OK”)

panel.add(button)

button.setPosition(100, 100)

launching a window intended to hold the panel and display that window on the computer display screen.

Such two step process is usual as it allows the logic of the GUI to be encapsulated in a single object class, the code of which is not necessarily (in fact seldom) accessible. The window displayed on the screen encapsulates common windowing functionality (close, minimize, maximize, etc.) and can be launched by the application at various points in the process through the following instructions:

window=new window

window.add(panel)

window.show

In up-to-date applications, the GUIs of an application have fixed display parameters. Only in some cases, the window (in a window oriented operating system) can be redimensioned and moved according to the basic OS mechanisms.

However, when application designers want to change a pre-existing GUI, and in particular to change et size and/or position of different components (panels, sub-panels, buttons, images, labels, input fields, etc.) of a (GUI, they need to access to the GUI source code and to change “by hand” the display or area parameters of these components

Such procedure requires to have free access to the application source code, which is not always the case. Further, such procedure involves fastidious programming of dimension data at the pixel level, unless a specific, sometimes costly, application generator is used.

### SUMMARY OF THE INVENTION

The present invention seeks to alleviate this drawback and to propose a method and device for modifying, e.g. customizing, a variety of GUIs in a simple and intuitive way, without requiring source code access or special tools.

Another object of the present invention is to allow implementation of the a method and device according to the present invention with pre-existing GUIs.

According to a first aspect, the present invention provides a method for modifying a pre-existing graphical user interface (GUI), said graphical user interface comprising a tree structure of GUI components each having a display area defined by area parameters, said graphical user interface being operable by a cursor control input device and at least some of the GUI components having listeners for responding to events from said input device, comprising the following steps:

(a) providing at least some of the components with a component mode indicator identifying the component as being in an operation mode or in an edit mode,

(b) detecting a main trigger event inputted by a users;

(c) upon occurrence of a main trigger event, inhibiting all component listeners and updating component mode indicators based on the location of the cursor relative to the component areas at the time of the main trigger event,

(d) when at least one component is in edit mode, detecting area parameter change events from the cursor controlled input device,

(e) when such area parameter change events occur, identifying from these events a target component for area parameter change and applying corresponding area parameter changes to the target component.

The method may further comprise the preliminary steps of:

establishing and storing a list of all listeners of graphical user interface component, and

registering a device adapted to perform the method as an input device event listener for at least some of the graphical user interface components.

The present invention also provides according to a second aspect a logical device for modifying a pre-existing graphical user interface (GUI), said graphical user interface comprising a tree structure of GUI components each having a display area defined by area parameters, said graphical user interface being operable by a cursor control input device and at least some of the GUI components having listeners for responding to events from said input device, comprising:

a mouse-type user-input listening device responsive to a main trigger event and to area parameter change events, and for identifying a current component area of the graphical

a mode manager for setting and storing mode indicator data for at least some of the GUI components, wherein each component mode indicator identifies the component as being in an operation mode or in an edit mode, said mode manager being responsive to main trigger event and cursor location at the occurrence of said main trigger events for changing component mode, and

a component area parameter changing device for changing at least one component area parameter of a given component of the graphical user interface in response to user inputted area parameter change events, wherein said given component is determined from said inputted area parameter change events and from said mode indicators.

Said mode indicators are preferably defined by a component path indentifying all components in edit mode, wherein two adjacent components in the path have a direct parent-to-child relationship.

In a preferred embodiment, the mode manager comprises:

a logic for identifying the component of lowest level in the tree structure, on which the cursor is located at the time of the main trigger event;

a logic for removing from the component path said component as well as any descendant component thereof if said component is contained in the component path,

a logic for identifying the closest ascendant component of said component which is itself contained in the component path, and adding to the component path the ascendant of said component which is a direct child of said closest ascendant, if said component is not contained in the component path.

In a typical implementation, said area parameter change events comprise a button depression, a cursor dragging and a button release, and wherein said area parameter changing devices is capable of:

detecting a button depression,

upon occurrence of such button depression, identifying as a target component a component meeting the following criteria:

the cursor is located in the area of this component at the time of button depression,

the component is a direct child of a component which is in edit mode, and

the component is not itself in edit mode, and

changing at least one area parameter of this component according to cursor movements between button depression and button release.

In addition, said area parameter changing device is further capable of:

determining a position of the cursor at the time of button depression relative to borders of the target component, and

depending of cursor position, selecting an area parameter change among an area resizing and an area displacement.

Advantageously, the device is an object oriented device and can be implemented by an instantiation instruction including a GUI identifier as an argument.

A method and device according to the present invention can easily be included in an existing GUI launching process with a very small amount of additional code whenever a window is created to display the GUI panel.

window=new window

window.add(panel)

customizer=new GUICustomizer(panel)

/* or customizer=new GUICustomizer( ) */

customizer.register(panel)

window.show

This procedure does not require any kind of access to the source code of the panel. The only condition to be met is that the panel should follow the so-called MVC (model-view-controller) design pattern or equivalent functionality. Such design pattern requires that all actions that the component recognizes should be handled by the triggering of a specific event, which will be broadcast to specific event listeners which have been added to the component and are subscribing to this particular event.

In addition, the component should verify the following three additional conditions:

the component should be able to access to a list of the sub-components that it contains: this is a corollary of object oriented design, which is itself implied in the context of MVC design pattern;

the component should be able to list the listeners that have subscribed to the events handled by the component and the methods used to add and remove such listeners (this is also implied in the context of MVC design pattern);

finally, the component should be able to provide methods for adding and removing listeners for each and any event handled by the component (which is again implied in the context of MVC design pattern).

### BRIEF DESCRIPTION OF THE DRAWINGS

Other aims, aspects and advantages of the present invention will appear more clearly from the following detailed description of a preferred embodiment thereof, made with reference to the appended drawings, wherein:

FIGS. 1-20 illustrate an exemplary GUI windows in different steps of customization according to the present invention.

### DETAILED DESCRIPTION OF A PREFERRED EMBODIMENT

### I—GUI Customizing Device Basic Operation

A so-called “GUI (for Graphical User Interface) customizing” software device is an implementation or an extension of a “MouseListener” type interface or class. By this is meant that GUI customizing device has the ability to listen to mouse (or other cursor-and-pointing device) inputs and trigger events accordingly, so as to customize a GUI having a main component (object instance) and one or several sub-components or children components (object instances of lower degree), which themselves can each have one or several sub-components or children components, etc., so as to typically define a tree structure.

The device listens in particular to three mouse events: mouse depressed, mouse released, and mouse dragged; in addition, the device listens for a particular mouse event called the main trigger event; this event is arbitrarily chosen to represent the action of entering or exiting edit mode this event should be chosen so that it causes no, or the least possible, conflict with other events recognized by the component for its normal operation. An example of a main trigger event could be a double click of the mouse left button, a double click of the mouse right button, a single click on the mouse right button while depressing the keyboard CTRL key, etc.

Such customizing device includes three main features:

a) it includes a logic for reacting to the main trigger event and for causing in that case a GUI component to switch from all “operation” mode, i.e. normal mode, to an “edit” mode, and vice versa.

b) it has an “edit” mode border management logic by which a specific border appearance of the GUI component is generated to visually indicate when a component is in “edit” mode; by default, this border specific appearance includes a rectangle with black handles, i.e. 8 small squares at the corners and sides of a thin rectangle superposed to the actual contour of the component.

c) it has a threshold management logic which indicates (typically by a pixel coordinate computation and comparison logic) the width of the area within any sub-component and around its borders in which a mouse depress event will be interpreted as an instruction to resize the sub-component or an instruction to displace the component, and in the former case an instruction to resize the component horizontally or to resize de component vertically or to resize the component with constant height-to-width ratio. All these features will be described in greater detail in the following.

### II—Device Registration

In order to operate, the customization device must be provided a GUI component for customization thereof. This process is termed here “registration”. Upon instantiation of the customization device, the device can either be passed to it a component in the form of an argument to its constructing instruction. Typical instruction are:

panel=new panel

customizer=new GUICustomizer(panel)

Alternatively, the customization device can be created without a component; in such case, this component can be added at a later stage. Typical instructions in that case would be:

panel=new panel

customizer=new GUICustomizer( )

customizer.register(panel)

This allows applications with multiple GUI panels either to use one customization device per panel, or to use a single customization device, and register each component in turn with it.

Upon registration, the device performs the following actions:

it makes and stores a list of all listeners currently registered with the component and its sub-components recursively;

it registers itself as a listener with the component and all its sub-components recursively.

Unregistration of a component causes the customization device to unregister itself from the component and all its sub-components recursively, and to erase its cache of the component's listeners.

### III—Normal Operation Mode

As long as the GUI component is in normal or “operation” mode together with all its sub-components, the GUICustomizer module does nothing but listen for a main trigger event as will be described in detail herebelow. Until this occurs, the GUI component behaves absolutely as it has been designed for.

### IV—Entering ‘Edit” Mode

Once the main trigger event occurs, the GUI component enters into an “edit” mode. This means that the normal behavior of the component is suspended while it is being edited, and the normal behavior of its sub-components is also suspended, while such sub-components are being edited.

More precisely, after the main trigger event occurs, the GUI customizing device performs the following steps:

the component border is replaced by the “edit” mode border set in the GUI customizing device in order to visually indicate to the user that the GUI component is in “edit” mode and that its normal behavior is suspended; the GUI component original border is memorized so that it can be restored when the component returns to normal or “operation” mode;

the GUI component listener devices (such as mouse and keyboard listeners) are inhibited; this has the effect of suspending the usual behavior of the component;

the listener devices of the sub-components of the GUI component are also inhibited; this has the effect of suspending the usual behavior of these sub-components; such process is repeated for the sub-components of each sub-component, if any;

### V—“Edit” Mode

At this stage, the GUI component is in “edit”mode. All mouse events are passed to the GUI customizing device and to no other listener device. The GUI customizing device then listens to the following three possible mouse events which can cause action at the customizing device:

a) Mouse Depressed (Left Button)

If the mouse is depressed while the display cursor thereof is situated on a sub-component area, then this sub-component is considered as the target for being either moved or resized, depending on the initial position of the mouse in the sub-component area. In a preferred embodiment, the sub-component will be either resized or moved according to the following rules:

if the initial mouse position was on or around the border of the sub-component, within a distance less than a threshold property of the device, the component will be resized; in such case, the mouse cursor preferably takes the shape of a double-sided arrow (north-south (i.e. vertical) if the mouse points to the top or bottom border, NE.-SW. (i.e. 45°) if the mouse is dragging the top right corner, etc.); the mouse will drag the side or the corner of the sub-component to which it is the closest;

if the initial mouse position was not on or around the sub-component's border, i.e. its distance from any of the sub-component's border was greater than the threshold property of the device, the sub-component is globally moved by dragging; the mouse cursor preferably takes in that case the shape of a 4-pointed or “crosshair” arrow (N., E., S., W.).

In each case the original cursor appearance (typically an oblique contoured arrow) is memorized so that it can be restored when the mouse is released.

b) Mouse Dragged

The dragging of the mouse over a sub-component (which implies a previous mouse depression event) will cause the actual resizing or moving. According to the action being performed, the whole component will be moved, or the border selected will be moved, or the corner selected will be move, as described hereinabove. The resizing and moving stops as soon as the dragging ends, i.e. when the mouse button is released as described hereinunder; it should be noted that mouse dragging while remaining within the borders of the component itself causes no action.

c) Mouse Released

When the mouse button is released, the original cursor appearance is restored.

d) Main Trigger Event

The GUI customizing device then continues to listen to the main trigger event. If this event occurs while the mouse cursor is above one of the sub-components of the GUI component, then this sub-component itself also enters into “edit” mode, i.e. appropriate mouse action can move or resize any sub-component of this sub-component. However, if at the time of the main trigger event the sub-component was already in edit mode, then it will exit edit mode.

It should be noted here that the fact that a given component is in edit mode basically means that its sub-components can themselves be moved or resized; exiting edit mode for said given component means that this sub-component as a whole will be moved or resized.

“Edit” mode management for complex sub-components will be described in at a later point of this description.

If the main trigger event occurs while the mouse is not on top of any sub-component of the GUI component (i.e. it is on top of another area within the display of the main component), then the GUI customizing device interprets this as an instruction to exit from “edit” mode and revert to normal or “operation” mode. The above-described process is reversed.

### VI—Exiting Edit Mode

When the main trigger event occurs while the main GUI component is in “edit” mode, the component will revert to normal or “operation” mode. The GUI customizing device then performs the following actions:

the original border appearance of the component is restored; in addition, if at the time of the event a sub-component of the component was currently selected, the original border appearance thereof will also be restored: further, if this sub-component was itself in “edit” mode at the time of the event, it will return to normal “operation” mode;

the original listeners (typically mouse and keyboard listener devices) of the component are restored in order that the original behavior of the component be resumed;

the original listeners are restored for each of the sub-components.

### VII—Special Issues

Herebelow is an additional description of special configurations where the GUI customizing device needs optional, additional features:

a) Case of Complex Sub-components

Many GUI components may contain sub-components which themselves contain lower degree or “sub-sub”-components, leading to a tree structure of embedded components that may have a significant number of levels from root component to leaf components. The method and system according to the present invention allows such components of a complex structure to be edited in the same manner, as follows:

when a main GUI component is in edit mode, if the main trigger event occurs while the mouse is over a sub-component, this sub-component will itself enter into edit mode, i.e. the sub-components thereof (which are sub-sub-components of the main component) can be resized and moved; the process is entirely recursive without any limitation as to depth of embedded components.

for that purpose, the GUI customizing device preferably defines two modes for each sub-component of a main component which is in “edit” mode. A sub-component can be either in “non-edit mode” mode, in which case it can be resized and moved as a whole. A sub-component can also be in “edit” mode, via a main trigger event, in which case its status relative to any of its sub-components becomes exactly like the status of the main component relative to the considered sub-component thereof.

Several specificities should however be noted:

a sub-component can be in “edit” mode only if its parent component is also in “edit” mode. Should at any time the parent component be returned to normal or “operation” mode, the child or sub-component will at the same time revert to normal or “operation” mode.

in most cases, the root component of a GUI cannot be resized and moved; as such root component typically occupies the whole space of its parent component (a standard practical case is where the root component is a main panel that occupies the whole space of the GUI window in a window-oriented operating system, and where the window resizing/moving it managed at the OS or application level).

components having no sub-components cannot enter into edit mode.

The GUI customizing device manages “edit” mode for the various components” preferably by keeping an ordered list of the components which are in “edit” mode. This list (which will be called in the following “component path”) starts with the topmost component of all these components (the root component in the component tree structure). If a first sub-component enters edit mode, it will be added to the list; if a second sub-component enters edit instead of the first, it will replace said first sub-component in the list.

When a main trigger event occurs, then the GUI customizing device makes a determination as to whether the mouse is over or outside the currently selected component, or another sub-component, or a sub-component of the currently selected sub-component, or over free space in the topmost component itself; the GUI customizing device can then take the appropriate action.

### VIII—Algorithms

a) Edit Mode Management

Herebelow is an outline of the logic performed by the customization device in response to mouse events in order to determine which component or sub-component should be processed (i.e. resized or moved) in the case of a main trigger event:

1. if a main trigger event occurs while the mouse cursor is on the GUI, and if the component path is empty, then set the main or root component to “edit” mode;

2. if a main trigger event occurs while the cursor is located on a (GUI component contained in the component path (i.e. on a component which currently is in edit mode), then restore this component, as well as any descendant component also contained in the component path;

3. if a main trigger event occurs while the cursor is located on a component that is not contained in the component path, then identify a so-called “target” component, i.e. a component to which the resizing/moving process as described hereinunder will be applied, this target component being defined as the first ancestor of this component which itself has a parent component contained in the component path; for example, if component A contains component B, component B contains component C, component C contains component D, component D contains component E, etc., and if components A and B are in edit mode, and E is the component where cursor lies while main trigger event occurs, then the “target” of the event should be component C (it should be noted here that if the component found as “target” is the main GUI component itself, then null is returned); if possible (i.e. if component C does have sub-components), component C is then set to edit mode, and the component path is updated to include component C, and any component at the same level as component C in the tree structure, which was contained in the component path, as well as any descendant therefrom, are removed from the tree structure. (Taking the above example, if the component path contained A-B-M-N-O, then M, N, O are to be restored and the component path will now contain A-B-C.

4. If the target component C has no sub-components, and therefore cannot enter into edit mode, then restore its parent from edit mode to normal mode, i.e. remove its parent from the component path.

b) Sub-component Resizing/moving Process

1. Pressing the mouse button while mouse cursor is over the main component (but avoiding any sub-component) will do nothing.

2. Pressing the mouse button while mouse cursor is over one of the sub-components will cause the following to occur:

the customizing device firsts determines as described above the “target” of the resizing/moving action;

the customizing device then determines from the position of the mouse cursor within the target component whether the action is intended to move or resize the component, as described above;

the cursor appearance is then changed to a specific cursor appearance indicating the type of action to be performed, as also described above; the original cursor appearance of the component is memorized for later restoration;

the customizing device also memorizes the original position of the cursor relative to the target component;

3. When the mouse is dragged, the customizing device re-calculates the dimensions or boundaries of the he target component relative to its parent component, by comparing the new position of the cursor (relative to the target component) with the cursor position memorized when the mouse button was pressed; the new dimensions are then recalculated according to the type action being performed (basically a certain type of resize or a move).

### IX—PRACTICAL EXAMPLE

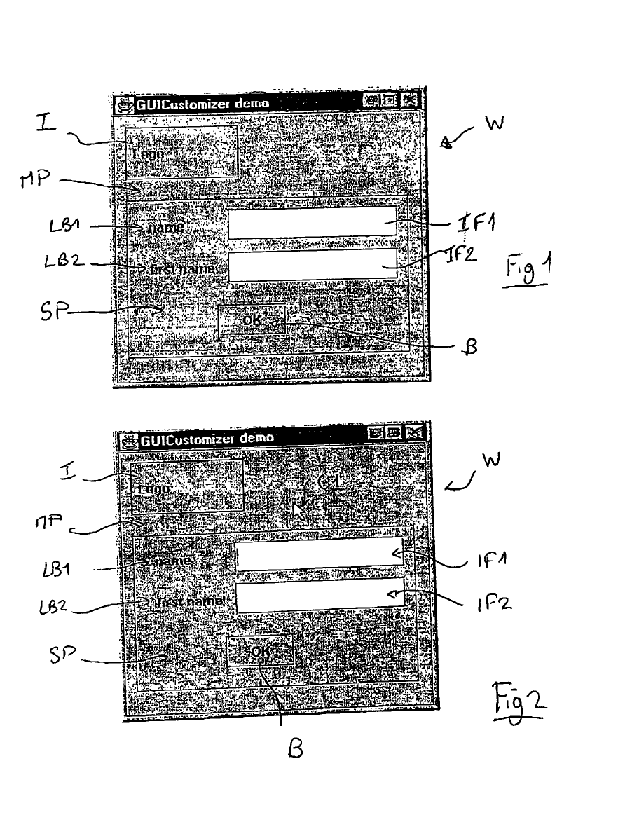

A practical example of a GUI window customization will now be given with reference to FIGS. 1-20 of the drawings.

FIG. 1 shows a sample GUI located in a standard window W and containing a main panel MP occupying the whole available area of the window; the main panel MP is the root component of the GUI and contains two sub-components, i.e. an image 1 of a logo, and a sub-panel SP having a visible rectangular contour; this sub-panel itself contains as sub-components two labels LB1 and LB2, two input fields IF1 and IF2, and a ‘OK’ button B. The GUI window in FIG. 1 is shown as appearing on the display when launched, without any mouse cursor.

In FIG. 2, the sample GUI is shown in normal mode, with the mouse cursor C1 (conventional oblique arrow type cursor) positioned on a free area within the main panel P, before the main trigger event.

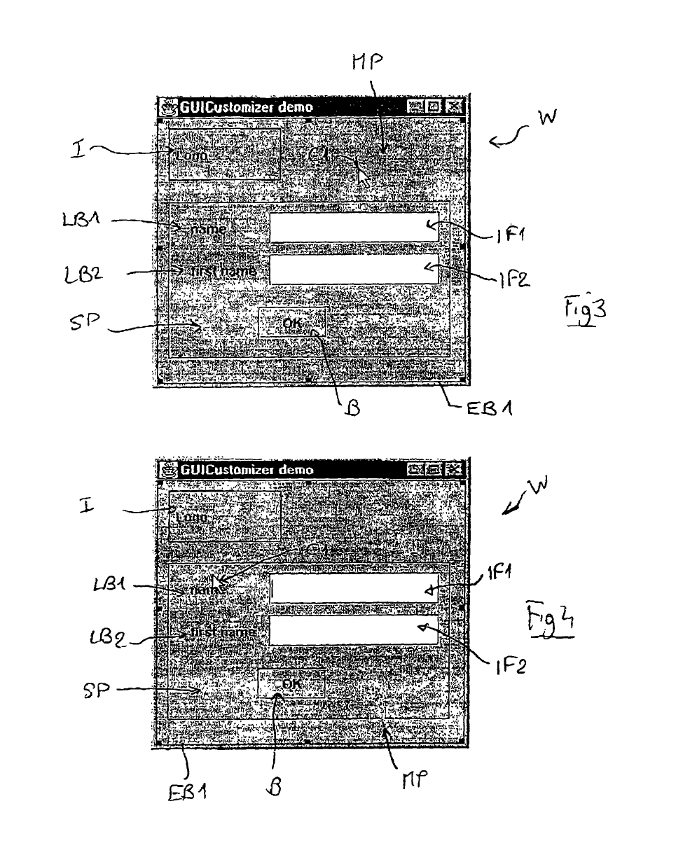

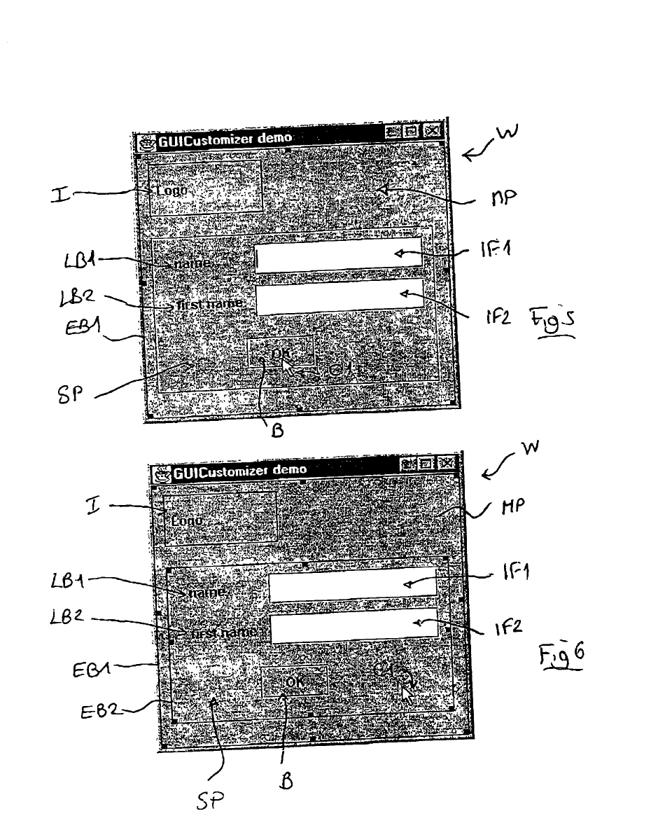

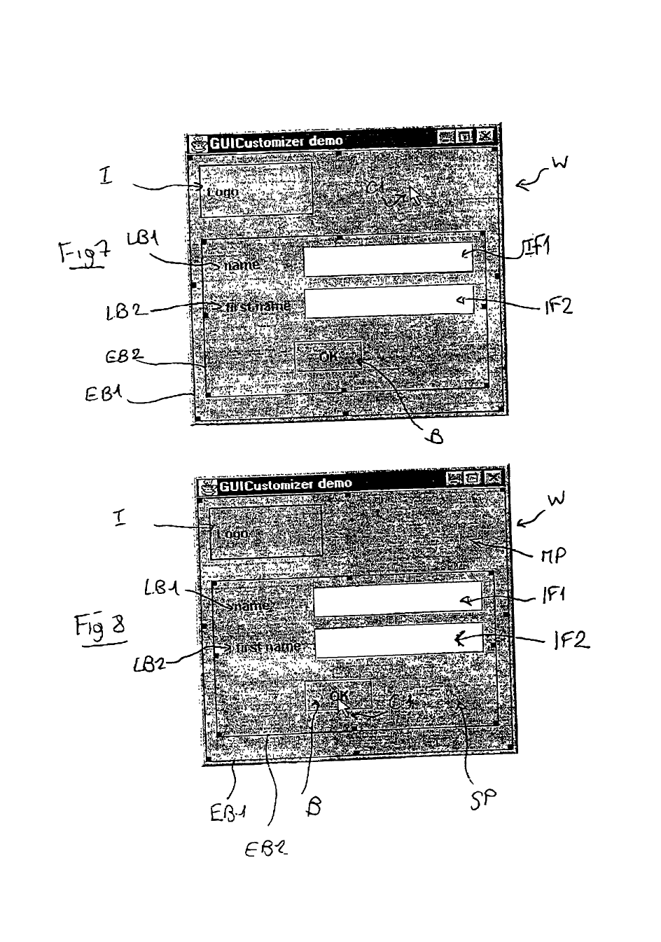

In FIG. 3, following the main trigger event (typically a left-button double click on the mouse), the GUI has entered the edit mode. Practically, it is the main panel MP, which is the component of higher rank for the customization device, which is in edit mode, and this is revealed by the presence of the edit border EB1 with plain squares around the main panel as shown; the component path thus contains the main panel only. The cursor C1 is still positioned on the main panel, which is in the component path; in such situation, a new occurrence of the main trigger event would cause the main panel MP to exit edit mode, and the edit border would disappear.

In FIG. 4, the sample GUI in edit mode as in FIG. 3, but the cursor C1 has been moved to the area of sub-panel SP. As before, the main panel MP is in edit mode, and the component path contains the main panel only. Since the cursor is positioned on the sub-panel SP, which is not in the component path, and since the ancestors of the sub-panel include the main panel only, which belongs to the component path, the target of a main trigger event would then be the sub-panel SP itself, so that causing the main trigger event to occur would cause the sub-panel SP to enter edit mode.

In FIG. 5, the sample GUI is still in edit mode, the main panel MP is still in edit mode, and the component path still only contains the main panel. The cursor C1 has been moved on top of the button B within sub-panel SP. The ancestors of the button B are the sub-panel SP, which is not in the component path, but whose parent (i.e. the main panel) is in the component path; the target of the main trigger event will therefore be the sub-panel SP, and causing the main trigger event to occur will cause the sub-panel SP to enter edit mode, exactly as illustrated with reference to FIG. 4).

Now referring to FIG. 6, the result of this is shown, with the sample GUI being in still edit mode, but both the main panel MP and the sub-panel SP being in edit mode, and the component path containing both the main panel and the sub-panel. The cursor C1 is positioned on the area of sub-panel SP, which is included in the component path; therefore, a main trigger event in such situation would cause the component SP to exit edit mode.

In FIG. 7, the sample GUI in edit mode; the main panel and the sub-panel are in edit mode, with their respective edit borders EB1 and EB2 displayed; the component path contains the main panel and the sub-panel. The cursor C1 is positioned on the main panel area MP; the main panel is in the component path, so that the main trigger event would cause the main panel to exit edit mode; since its descendant the sub-panel is also in edit mode, the display data of the latter would also be restored.

As shown in FIG. 8, the sample GUI in edit mode; both the main panel MP and the sub-panel SP are in edit mode; the component path includes the main panel MP and the sub-panel SP. The cursor C1 is positioned over the OK button B which is a child component of the sub-panel component; the button B has no sub-components, and therefore cannot enter edit mode; the main trigger event in such situation would therefore cause the sub-panel SP to exit edit mode.

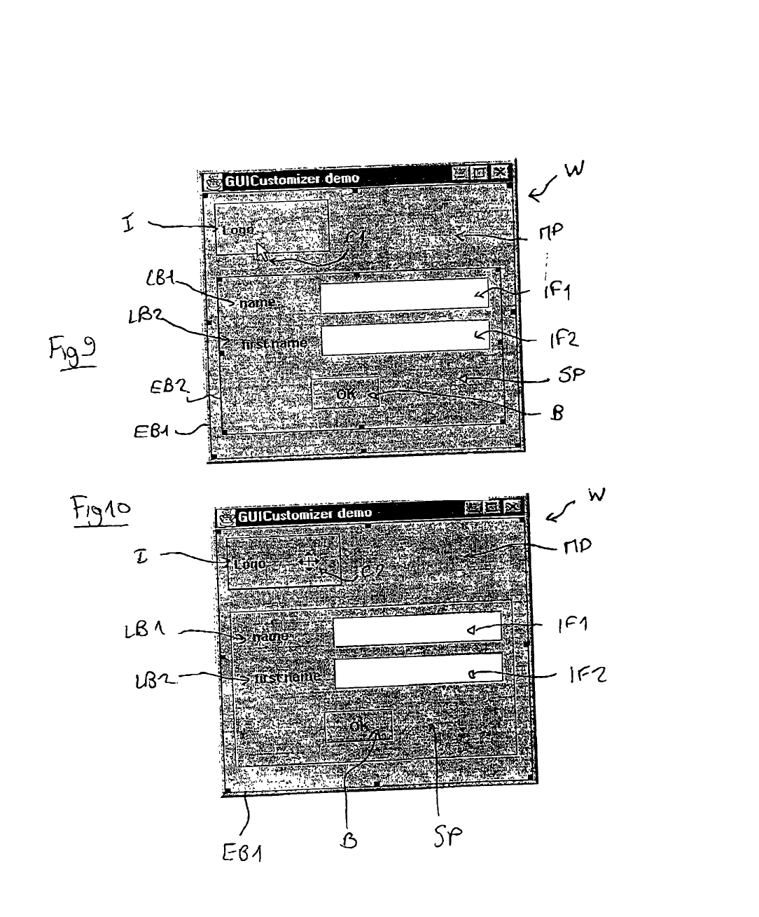

Turning now to FIG. 9, the sample GUI in edit mode; both the main panel MP and the sub-panel SP are in edit mode, with their edit borders EB1 and EB2 displayed; the component path includes the main panel MP and the sub-panel SP. The cursor C1 has been moved over the logo image I, which is a child component of the main panel component; the logo image has no sub-components, and therefore cannot enter edit mode; the main trigger event would therefore cause the main panel to exit edit mode; but since the sub-panel component, which is a child component of the main panel component, is also in edit mode, it would exit edit mode at the same time.

In FIG. 10, the sample GUI is still in edit mode; the main panel is in edit mode, but the sub-panel is not in edit mode, as described above. A left button click on the mouse has been performed while cursor C1 was on the logo image I; therefore a “crosshair” cursor C2 has replaced cursor C1, which indicates that this sub-component (image I) can be displaced by dragging in any direction.

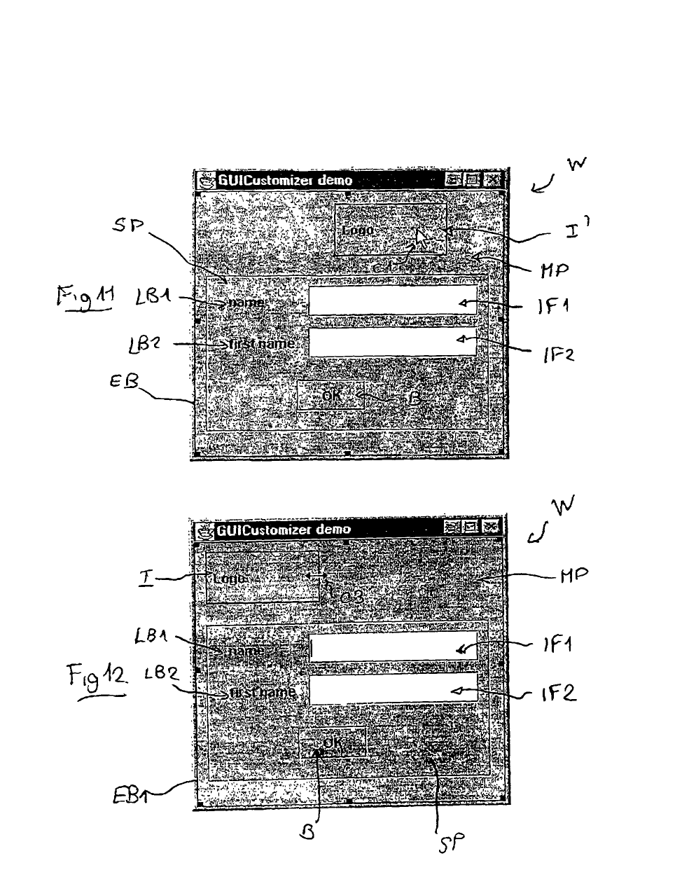

The result of this displacement is shown in FIG. 11, the displaced logo image being indicated in I′. When the mouse button has been released after displacing the logo image, the original cursor C1 has been restored.

Turning to FIG. 12, the GUI is still in edit mode; the main panel only being in edit mode with its edit border EB1 being displayed. The mouse left button has been depressed while cursor (C1 type) was in the vicinity of the right hand edge of the logo image sub-component I, so that the cursor bas been changed to horizontal double arrow as shown in C3, indicating that this component can be resized horizontally by dragging its right-hand edge.

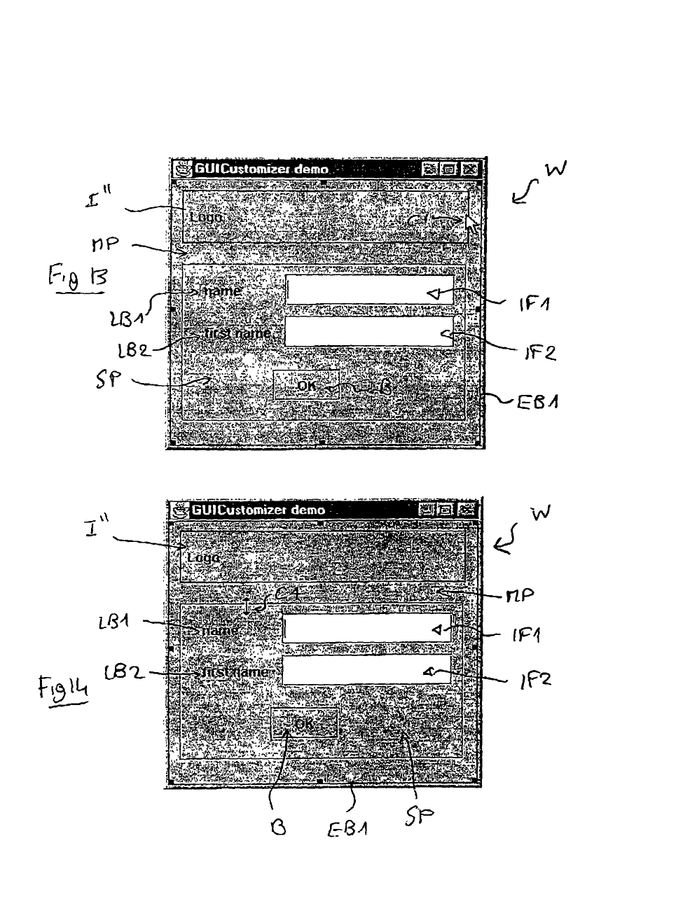

In FIG. 13, the cursor C3 has been displaced with the mouse toward the right, and the left button thereof has been released after resizing the logo image sub-component I. The original cursor appearance C1 has been restored, and FIG. 13 shows the logo image I extended in horizontal direction.

Now referring to FIG. 14, the GUI is in edit mode; the main panel MP is in edit mode. The mouse button has been depressed while the mouse cursor (C1 type) was in the vicinity of the top edge of the contour of sub-panel SP; the cursor appearance was then changed to a vertical double arrow (shown in C4), indicating that this sub-component can be resized vertically by dragging its top edge with the mouse.

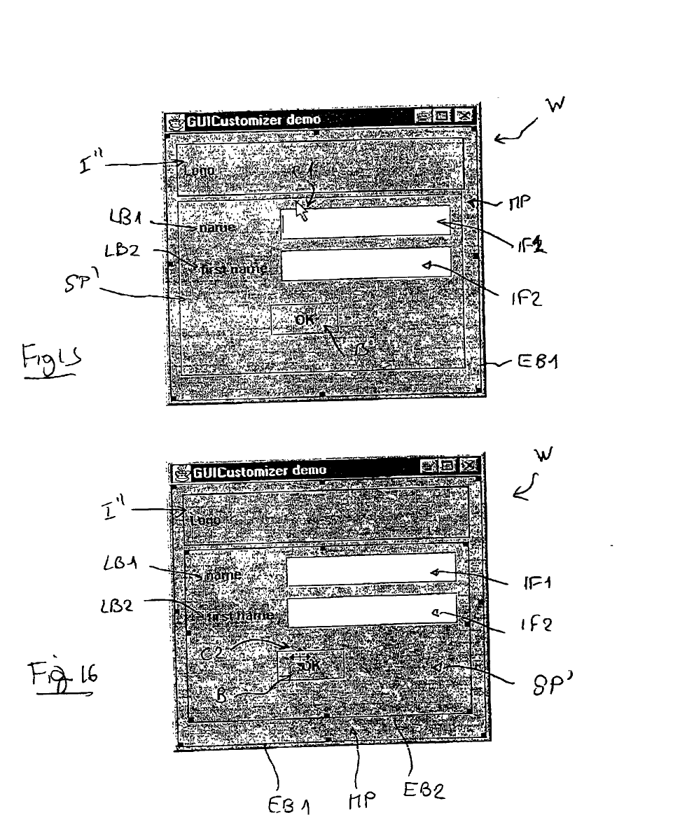

FIG. 15 shows the situation after such dragging in an upward direction occurred and with the mouse button released, the sub-panel has been enlarged vertically and is now indicated by SP. The original cursor C1 has been restored.

In FIG. 16, the GUI panel is in edit mode, with both the main panel MP and the sub-panel SP′ being in edit node with their respective edit borders EB1, EB2. When the mouse left button is depressed while cursor C1 was on button B, then the cursor display changes to crosshair type C2 as shown, indicating that the button component B can be displaced by dragging in any direction.

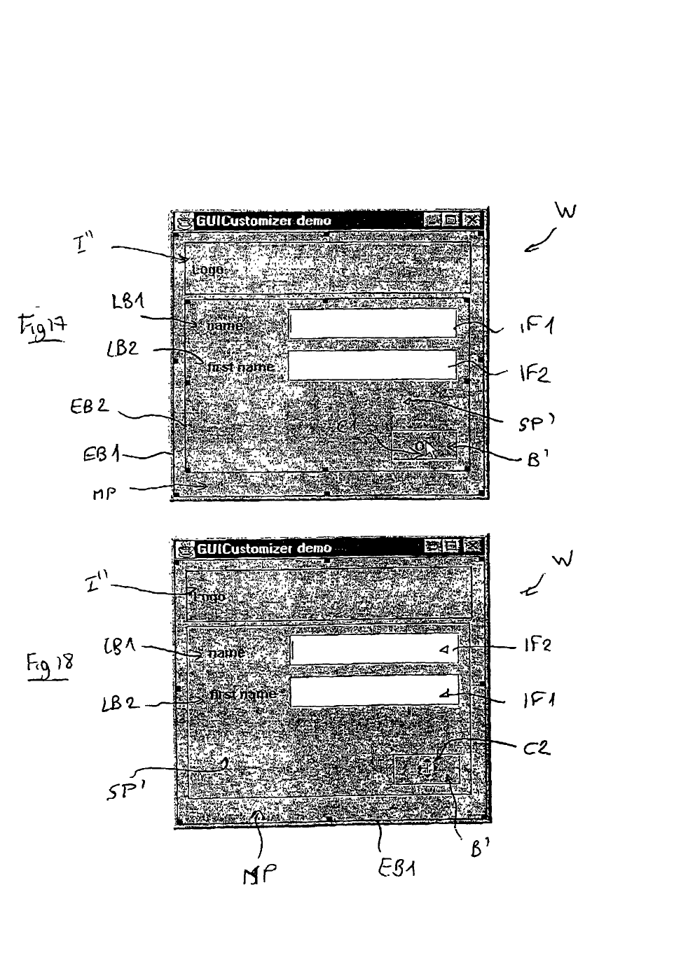

FIG. 17 shows the situation after dragging to the right occurred and the mouse button has been released. The ‘OK’ button has been displaced (and shown at B′), and the original cursor appearance C1 has been restored.

A similar action is shown in FIG. 18: the GUI is in edit mode, but contrary to the situation of FIG. 16, the main panel is in edit mode but the sub-panel is no longer in edit mode; in such case, when the mouse left button has be depressed while cursor C1 was on top of the ‘OK’ button B within sub-panel SP′, then the fact that the sub-panel is shown as not being in edit mode means that mouse dragging will impact the sub-panel in its entirety with all its descendant components (and not the ‘OK’ button only).

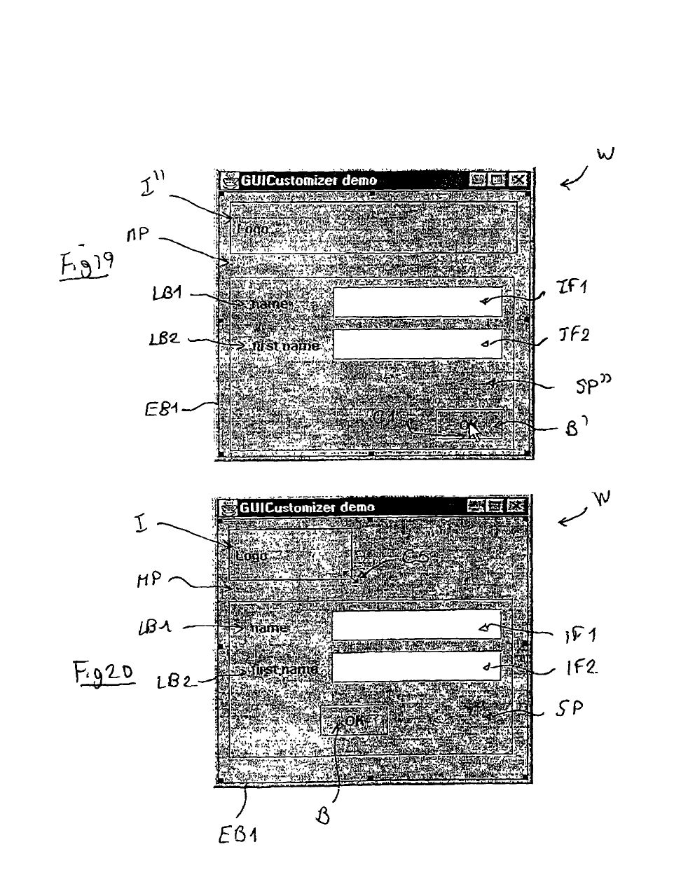

FIG. 19 shows the result of the mouse button has been released after dragging the sub-panel in a downward directions the displaced sub-panel being indicated at SP″. The original cursor has been restored.

Finally, FIG. 20 shows the situation where the mouse button has been depressed while the cursor C1 was in the vicinity of a corner of a component contour (in this case the logo image I). In such case, the cursor takes the appearance of a 45° double arrow, indicating that the component can be resized by moving the mouse, with its width-to-height ratio remaining unchanged. Here again, the cursor will restore its original appearance (C1 type) after resizing, i.e. when the mouse button is released.

The present invention is not limited to the foregoing embodiment, but many variants and changes may be brought thereto.

1. A method for modifying a pre-existing graphical user interface (GUI), said graphical user interface comprising a tree structure of GUI components each having a display area defined by area parameters, said graphical user interface being operable by a cursor control input device and at least some of the GUI components having listeners for responding to events from said input device, comprising the following steps:
(a) providing at least some of the components with a component mode indicator identifying the component as being in an operation mode or in an edit mode,
(b) detecting a main trigger event inputted by a user;
(c) upon occurrence of a main trigger event, inhibiting all component listeners and updating component mode indicators based on the location or the cursor relative to the component areas at the time of the main trigger event,
(d) when at least one component is in edit mode, detecting area parameter change events from the cursor controlled input device,
(e) when such area parameter change events occur, identifying from these events a target component for area parameter change and applying corresponding area parameter changes to the target component.

2. A method according to claim 1, wherein said mode indicators are defined by a component path identifying all components in edit mode.

3. A method according to claim 2, wherein said component path includes a sub-set of components, wherein two adjacent components in the path have a direct parent-to-child relationship.

4. A method according to claim 3, wherein step (c) includes the following sub-steps:
(c1) identifying the component of lowest level in the tree structure, on which the cursor is located at the time of the main trigger event;
(c2) if said component is contained in the component path, then removing from the component path said component as well as any descendant component thereof;
(c3) if said component is not contained in the component path, then identifying the closest ascendant component of said component which is itself contained in the component path, and adding to the component path the ascendant of said component which is a direct child of said closest ascendant.

5. A method according to claim 1, wherein said area parameter change events comprise a button depression, a cursor dragging and a button release, and wherein step (e) comprises the following sub-steps:
(e1) detecting a button depression,
(e2) upon occurrence of which button depression, identifying as a target component a component meeting the following criteria:
the cursor is located in the area of this component at the time of button depression,
the component is a direct child of a component which is in edit mode, and
the component is not itself in edit mode,
(e3) changing at least one area parameter of this component according to cursor movements between button depression and button release.

6. A method according to claim 5, wherein step (e) further comprises, between sub-steps (e2) and (e3), the following sub-steps:
(e2′) determining a position of the cursor at the time of button depression relative to borders of the target component,
(e2″) depending of cursor position, selecting an area parameter change among an area resizing and an area displacement.

7. A method according to claim 1, further comprising the preliminary steps of:
establishing and storing a list of all listeners of graphical user interface components, and
registering a device adapted to perform the method as an input device event listener for at least some of the graphical user interface components.

8. A logical device for modifying a pre-existing graphical user interface (GUI), said graphical user interface comprising a tree structure of GUI components each having a display area defined by area parameters, said graphical user interface being operable by a cursor control input device and at least some of the GUI components having listeners for responding to events from said input device, comprising:
a mouse-type user-input listening device responsive to a main trigger event and to area parameter change events, and for identifying a current component area of the graphical
a mode manager for setting and storing mode indicator data for at least some of the GUI components, wherein each component mode indicator identifies the component as being in an operation mode or in an edit mode, said mode manager being responsive to main trigger event and cursor location at the occurrence of said main trigger events for changing component mode, and
a component area parameter changing device for changing at least one component area parameter of a given component of the graphical user interface in response to user inputted area parameter change events, wherein said given component is determined from said inputted area parameter change events and from said mode indicators.

9. A device according to claim 8, wherein said mode indicators are defined by a component path identifying all components in edit mode.

10. A device according to claim 9, wherein said component path includes a sub-set of components, wherein two adjacent components in the path have a direct parent-to-child relationship.

11. A device according to claim 3, wherein said mode manager comprises:
a logic for identifying the component of lowest level in the tree structure, on which the cursor is located at the time of the main trigger event;
a logic for removing from the component path said component as well as any descendant component thereof if said component is contained in the component path,
a logic for identifying the closest ascendant component of said component which is itself contained in the component path, and adding to the component path the ascendant of said component which is a direct child of said closest ascendant, if said component is not contained in the component path.

12. A device according to claim 8, wherein said area parameter change events comprise a button depression, a cursor dragging and a button release, and wherein said area parameter changing devices is capable of:
detecting a button depression,
upon occurrence of such button depression, identifying as a target component a component meeting the following criteria:
the cursor is located in the area of this component at the time of button depression,
the component is a direct child of a component which is in edit mode, and
the component is not itself in edit mode, and
changing at least one area parameter of this component according to cursor movements between button depression and button release.

13. A device according to claim 12, wherein said area parameter changing device is further capable of:
determining a position of the cursor at the time of button depression relative to borders of the target component, and
depending of cursor position, selecting an area parameter change among an area resizing and an area displacement.

14. A device according to claim 8, wherein it is an object oriented device and wherein it can be implemented by an instantiation instruction including a GUI identifier as an argument.
